(19) United States
(12) Patent Application Publication
(10) Pub. No.: US 2008/0012300 A1
(43) Pub. Date: Jan. 17, 2008

(54) Iron fitting for stainless steel tubing

(75) Inventors: Scott Duquette, Enfield, CT (US); Brian R. Kraft, Palmer, MA (US)

Correspondence Address: FOLEY AND LARDNER LLP;SUITE 500, 3000 K STREET NW, WASHINGTON, DC, 20007, US

(73) Assignee: TITEFLEX CORPORATION

(21) Appl. No.: 11/247,326

(22) Filed: Oct. 12, 2005

(51) Int. Cl. F16L 33/00

(52) U.S. Cl. 285/247

(57) ABSTRACT

A fitting assembly for forming a fluid-tight seal with an end of a stainless steel tube is provided with an adapter that is made of a material that is different from the material that the seal seat is made of. The material selected for the adapter is relatively less expensive than brass and the manufacturing method for making the adapter is relatively less expensive than that for making conventional adapters that are entirely made out of brass. According to an embodiment of the present invention, the adapter may be made of iron. According to an embodiment of the present invention, the seal seat may be made of a material that is softer than the material that the stainless steel tube is made of. According to another embodiment of the present invention, the seal seat may be made of a material that is harder than the material that the stainless steel tube is made of.

### BACKGROUND

The present invention relates to a fitting assembly and seal seat for forming a fluid-tight seal with an end of a stainless steel tube.

In a conventional fitting design for sealing an end of a stainless steel tube, the fitting components, such as the adapter body, are made from brass. While brass is a suitable material for fitting assemblies in terms of physical properties and corrosion resistance, brass is somewhat expensive in price. Therefore, a less expensive fitting assembly may be produced by constructing fitting assembly components out of materials that are less costly than brass, and by employing a less expensive manufacturing method.

### SUMMARY OF THE INVENTION

It is an object of the present invention to provide an improved fitting assembly and seal seat for sealing an end of a stainless steel tube to create a fluid-tight seal. It is an object of the present invention to provide an adapter that is less expensive to manufacture.

In an aspect of the present invention, material selection and manufacturing processing results in a less expensive fitting assembly. In an aspect of the present invention, a more cost-efficient fitting assembly is provided by employing suitable materials with lower costs than brass. In an aspect of the present invention, a more cost-efficient fitting assembly is provided by employing a less costly manufacturing method. In the embodiments that follow, fluids may include gases and liquids.

According to an embodiment of the present invention, a fitting assembly for forming a fluid-tight seal with a stainless steel tube includes a gripping device, an adapter, wherein the adapter is made of iron, and a seal seat to be placed adjacent to a cut end of the stainless steel tube, wherein the seal seat is made of a material that is different than a material that the adapter is made of.

According to an embodiment of the present invention, an adapter for forming a fluid-tight seal with a stainless steel tube includes an adapter, wherein the adapter is made of iron.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a sectional view of a fitting assembly according to an embodiment of the present invention.

FIG. 2 is a sectional view of a seal seat according to an embodiment of the present invention.

FIG. 3 is an end view of a seal seat according to an embodiment of the present invention.

FIG. 4 is a sectional view of a fitting assembly according to an embodiment of the present invention.

FIG. 5 is a sectional view of a seal seat according to an embodiment of the present invention.

### DETAILED DESCRIPTION

Embodiments of the present invention will be described below with reference to the drawings.

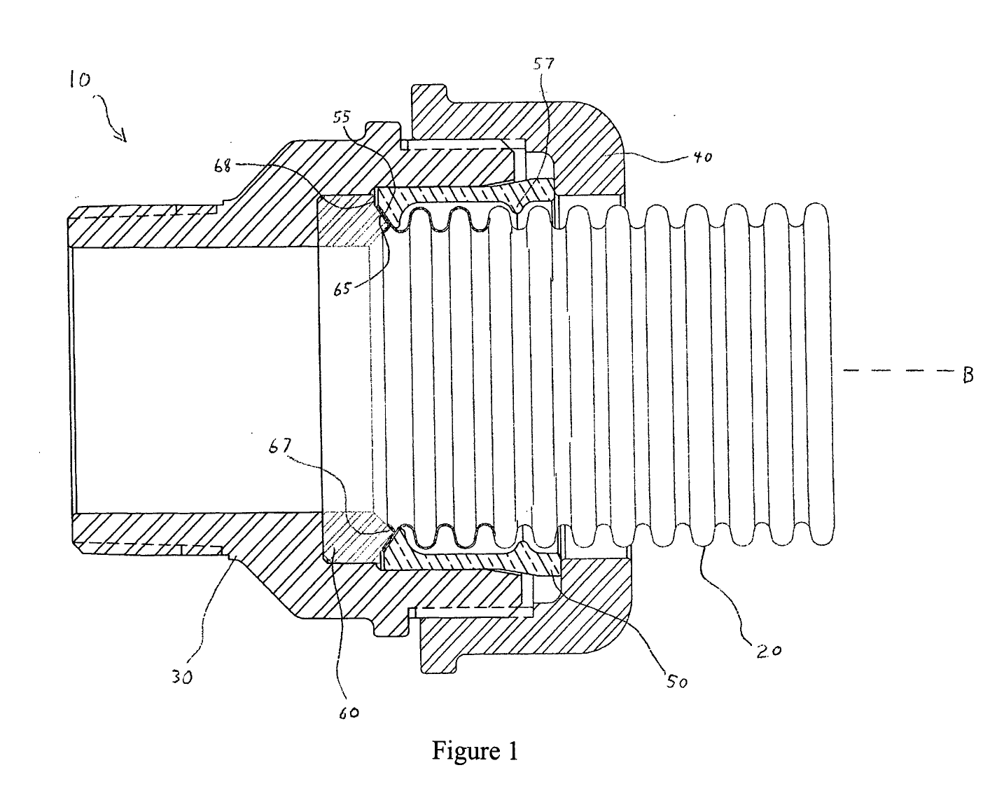

FIG. 1 shows a fitting assembly according to an embodiment of the present invention. The fitting assembly 10 may be used to seal an end of a stainless steel tube 20 to create a fluid-tight seal. In the example shown in FIG. 1, a corrugated stainless steel tube is shown. The stainless steel tube 20 may have one of its ends cut in preparation to form a seal with the fitting assembly 10. The fitting assembly 10 may include an adapter 30 and a nut 40. The adapter may include a bushing 50 as well.

FIG. 1 shows an example of a state in which a stainless steel tube 20 has been inserted into the fitting assembly 10. In normal operation the stainless steel tube 20 is inserted into the fitting assembly 10 by first removing the nut 40 from the adapter 30. The bushing 50 may be then removed from the nut 40 or from the adapter 30. The bushing 50 may be a unitary piece or have a design of two or more pieces. The bushing 50 may be separate from the nut 40 or the bushing 50 may be attached to the nut 40. The bushing 50 may then be placed over the outer diameter of the stainless steel tube 20 and the stainless steel tube 20 and bushing 50 may then be inserted into the adapter 30. The nut 40 may then be screwed onto the adapter 30 to assemble the fitting assembly 10.

Conventionally, adapters have been made as a one-piece part machined from a material that is softer than the material that the stainless steel tube 20 is made of. Commonly, the adapter is constructed as a one-piece part that is made of brass. Although brass is a suitable material selection for an adapter because brass has sufficient physical properties and corrosion resistance, brass is relatively expensive to use. Therefore, a cost-savings may be achieved in the manufacture of fitting assemblies if less expensive materials may be selected.

In an embodiment of the present invention, an adapter 30 is provided, with the adapter 30 being made of iron. Iron is a material with suitable physical properties and is relatively less expensive than brass. The adapter 30 may be made of any grade of iron, such as cast iron, wrought iron, ductile iron, gray iron, white iron, malleable iron, and other grades of iron known in the art. The adapter 30 may include a seal seat 60 that is made of a material that is different than the material that the adapter 30 is made of.

In an embodiment of the present invention, the adapter 30 may be made of steel. For example, the adapter 30 may be made of carbon steel, mild steel, alloy steel, tool steel, or other steels known in the art.

In a further embodiment of the present invention, the nut 40 may also be made of iron.

In an embodiment of the present invention, a fitting assembly 10 includes an adapter 30 that is made of a material that is different than the material that a seal seat 60 is made of. Iron is a material with suitable physical properties and is relatively less expensive than brass. The adapter 30 may be made of cast iron, wrought iron, ductile iron, gray iron, white iron, malleable iron, and other grades of iron known in the art. The adapter 30 may also be made of steel. For example, the adapter 30 may be made of carbon steel, mild steel, alloy steel, tool steel, or other steels known in the art.

In an embodiment of the present invention, the fitting assembly 10 may include a coating. The coating may be made of a corrosion-resistant material, a wear-resistant material, or a material that is harder than the stainless steel tube 20. The coating may be a corrosion-resistant material to protect the underlying materials that the components of the fitting assembly 10 are made of. For example, the coating 32 may be black oxide, electroless nickel, cadmium plating, or other corrosion-resistant coatings known in the art. The coating may be applied to the entire fitting assembly 10, to portions of the fitting assembly 10, to selected components or portions of components of the fitting assembly 10, or the fitting assembly 10 may not include a coating.

In an embodiment of the present invention, the adapter 30 may be made of a different material than the material that the seal seat 60 is made of, with the seal seat 60 being made of a material that is softer than that material that the stainless steel tube is made of. For example, the seal seat 60 may be made of brass or other relatively soft alloys known in the art.

In an embodiment of the present invention, the adapter 30 may be made of a different material than the material that the seal seat 60 is made of, with the seal seat 60 being made of a material that is harder than that material that the stainless steel tube is made of. Because the seal seat 60 is made of a material that is harder than the material that the stainless steel tube is made of, the fitting assembly 10 is less sensitive to the quality of the cut end of the stainless steel tube 20 and the fitting assembly 10 is less sensitive to foreign materials. For example, the seal seat 60 may be made of carbon steel, tool steels, martensitic stainless steels, precipitation hardening stainless steels, alloy steels, and other alloys that are harder than the material that the stainless steel tube 20 is made of. In a preferred embodiment of the present invention, the seal seat 60 is made of a martensitic stainless steel or tool steel, where the steel is in a hardened condition.

The adapter 30 may be manufactured by using a casting process. For example, the adapter 30 may be manufactured by using sand casting, die casting, investment casting, or other casting processes known in the art. After casting is complete, machining may be performed to bring the adapter 30 within desired dimensional tolerances.

In an embodiment of the present invention, the seal seat 60 may be a piece that is separate from the adapter 30 so that the seal seat 60 and adapter 30 are fitted together when the fitting assembly 10 is tightened so that the fitting assembly 10 and the stainless steel tube 20 are joined together.

In an embodiment of the present invention, the seal seat 60 may be attached to the adapter 30. For example, the seal seat 60 may be press fit, brazed, welded, fastened, or joined by other processes known in the art.

The fitting assembly 10 may be provided with a hex-shaped area for wrenching and tightening the fitting assembly, or the fitting assembly may provide a cylindrical area for wrenching with a pipe wrench. The latter area may include ridges that serve as pipe wrench stops and as reinforcement.

After a stainless steel tube 20 has been inserted into the fitting assembly 10 and the fitting assembly 10 has been assembled together, the nut 40 may be tightened onto the adapter 30 to form a fluid-tight seal between the fitting assembly 10 and the stainless steel tube 20. When the nut 40 is tightened onto the adapter 30, the stainless steel tube 20 may be pressed between the bushing 50 and the seal seat 60. For example, the stainless steel tube 20 may be pressed between a bushing surface 55 and a seal seat surface 65. In this way, the stainless steel tube 20 may be gripped by the bushing 50 and the seal seat 60 to form a fluid-tight seal with the stainless steel tube 20.

Once the stainless steel tube 20 is sealed between the bushing 50 and the seal seat 60, the nut 40 may be tightened further onto the adapter 30, causing the stainless steel tube to deform between the bushing 50 and the seal seat 60. For example, tightening the nut 40 further may press the stainless steel tube 20 between the bushing surface 55 and the seal seat surface 65 so that the stainless steel tube 20 deforms and creates a fluid-tight seal with the fitting assembly 10. The surfaces of the bushing 50 and the seal seat 60 may be angled and sloped to aid with the sealing and/or deformation of the stainless steel tube 20.

The stainless steel tube 20 may be cut so that it abuts against the seal seat surface 65 or the stainless steel tube 20 may be cut so that it abuts against the seal seat surface 65 and wraps around the seal seat 60 to also abut an inner surface 67. The seal seat surface 65 may be shaped so that it is angled to a longitudinal axis B of the stainless steel tube 20. The inner surface 67 may be shaped so that it is angled to a longitudinal axis B of the stainless steel tube 20. Perpendicular surface 68 may be shaped so that it is perpendicular to the longitudinal axis B of the stainless steel tube 20.

The bushing 50 may include one or more protrusions 57 for gripping and sealing with the exterior of the stainless steel tube 20. The stainless steel tube 20 may be a corrugated tube or a straight tube.

Other gripping devices may be used instead of the nut 40 and the bushing 50 shown in the example of FIG. 1. For example, a nut-integrated collet, a colleted nut, a slip or other types of rings, and other gripping devices known in the fitting arts may be used.

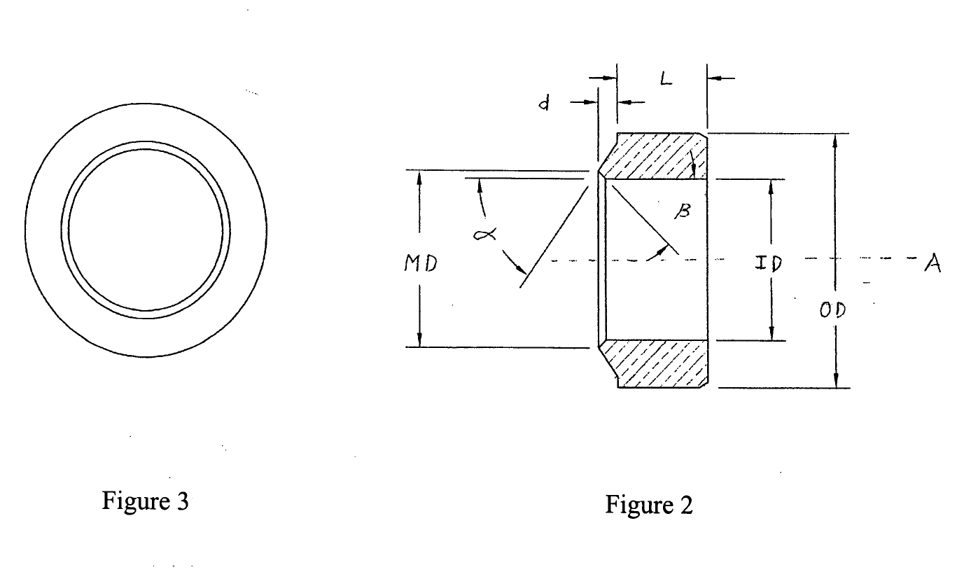

FIG. 2 shows a sectional view of the seal seat 60 according to an embodiment of the present invention. FIG. 3 shows an end view of the seal seat 60 according to an embodiment of the present invention. The seal seat 60 may have an inner diameter ID, an outer diameter OD, a mouth diameter MD, and a length L. The dimensions of the seal seat 60 may be selected in accordance with the dimensions of the adapter 30 and other components of the fitting assembly 10, and to promote sealing and/or deformation of the stainless steel tube 20 to form a fluid-tight seal.

For example, the seal seat 60 may have an inner diameter ID of 0.562 inches, an outer diameter OD of 0.882 inches, a mouth diameter MD of 0.615-0.617 inches, and a length L of 0.323 inches.

The surfaces of the seal seat 60 may be dimensioned in accordance with other components of the fitting assembly 10 and to promote the sealing and/or deformation of the stainless steel tube 20 to form a fluid-tight seal. A sloped face of the seal seat may have a depth d and form angles α and β with a longitudinal axis A of the seal seat 60.

For example, the seal seat 60 may have a sloped face with a depth d of 0.069 inches, an angle α of 55°, and an angle β of 45°.

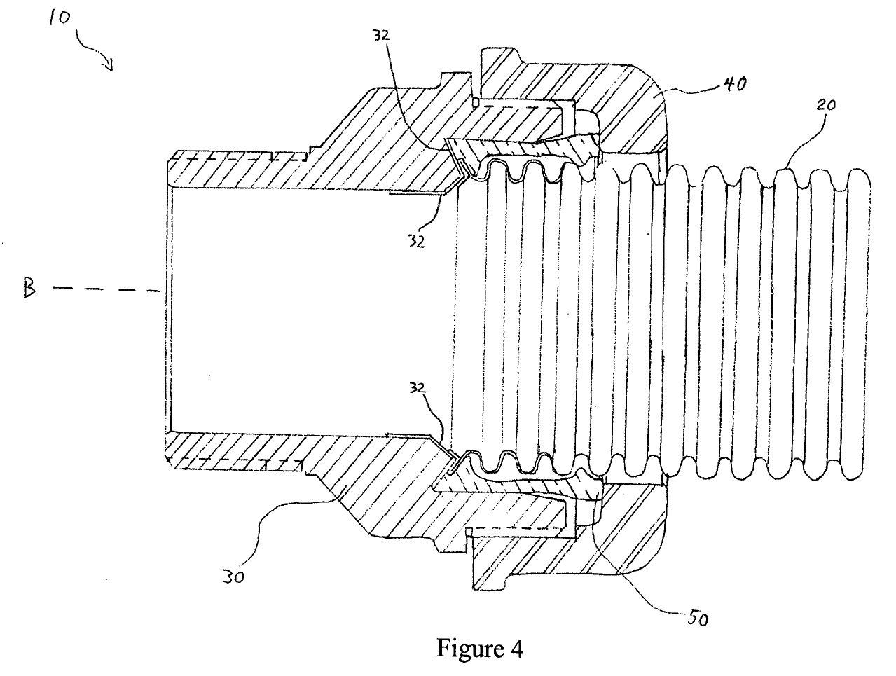

FIG. 4 shows a sectional view of a fitting assembly 10 according to an embodiment of the present invention. In the example shown in FIG. 4, the adapter 30 is made of a single piece that includes a portion that corresponds to the seal seat 60 described above. Therefore, the adapter 30 and the seal seat 60 may be formed by a single, integrated piece. The adapter 30 may include a coating 32 that has been applied to the areas of the adapter 30 that will contact with the stainless steel tube 20 to form a seal. The coating 32 may be made of a corrosion-resistant material, a wear-resistant material, or a material that is harder than the stainless steel tube 20. The coating 32 may be a corrosion-resistant material to protect the underlying material that the adapter 30 and seal seat are made of. For example, the coating 32 may be black oxide, electroless nickel, cadmium plating, or other corrosion-resistant coatings known in the art.

When the coating 32 is made of a material that is harder than the material that the stainless steel tube 20 is made of, the fitting assembly 10 is less sensitive to the quality of the cut end of the stainless steel tube 20 and the fitting assembly 10 is less sensitive to foreign materials. Because the adapter 30 includes the coating 32, the adapter 30 is less likely to be damaged by a poorly cut end of the stainless steel tube 20 and the adapter 30 is less likely to be damaged by foreign materials.

The coating 32 may applied to the adapter by electroplating, dipping, sputtering, chemical vapor deposition (CVD), thermal spraying, or by other coating processes known in the art.

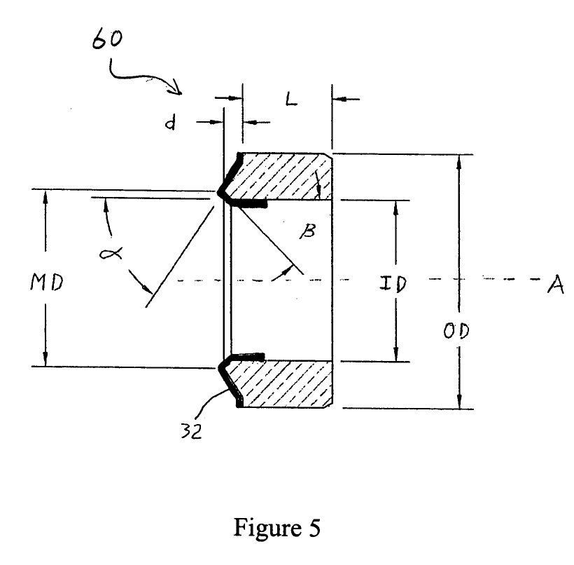

FIG. 5 shows a sectional view of a seal seat 60 according to an embodiment of the present invention. In the example of FIG. 5, the seal seat 60 includes a coating 32 that has been applied to the areas of the adapter 30 that will contact with the stainless steel tube 20 to form a seal. The coating 32 may be made of a corrosion-resistant material, a wear-resistant material, or a material that is harder than the stainless steel tube 20, as described in the embodiment above. The seal seat 60 may be made of a material that is harder or softer than the material that the stainless steel tube 20 is made of. The seal seat 60 may be a piece that is separate from the adapter 30, as shown in FIG. 5, or the seal seat 60 may be joined to the adapter 30, as described in the embodiment above.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A fitting assembly for forming a fluid-tight seal with a stainless steel tube, comprising:
a gripping device;
an adapter, wherein the adapter is made of iron; and
a seal seat to be placed adjacent to a cut end of the stainless steel tube;
wherein the seal seat is made of a material that is different than a material that the adapter is made of.

2. The fitting assembly of claim 1, wherein the seal seat and the adapter are separate pieces.

3. The fitting assembly of claim 1, wherein the seal seat is an insert that is joined to the adapter.

4. The fitting assembly of claim 1, wherein the seal seat and the adapter form a single, integral piece.

5. The fitting assembly of claim 1, wherein the seal seat is made of a material that is softer than a material that the stainless steel tube is made of.

6. The fitting assembly of claim 5, wherein the seal seat is made of brass.

7. The fitting assembly of claim 1, wherein the seal seat is made of a material that is harder than a material that the stainless steel tube is made of.

8. The fitting assembly of claim 7, wherein the seal seat is made of hardened martensitic stainless steel.

9. The fitting assembly of claim 7, wherein the seal seat is made of hardened tool steel.

10. The fitting assembly of claim 1, wherein the gripping device comprises a bushing.

11. The fitting assembly of claim 1, wherein the gripping device includes at least one protrusion for gripping and sealing with the stainless steel tube.

12. The fitting assembly of claim 1, wherein the seal seat is coated with a coating material, wherein the coating material is a corrosion-resistant material, a wear-resistant material, or a material that is harder than a material that the stainless steel tube is made of.

13. The fitting assembly of claim 12, wherein the seal seat and the adapter are separate pieces.

14. The fitting assembly of claim 12, wherein the seal seat is an insert that is joined to the adapter.

15. The fitting assembly of claim 12, wherein the seal seat and the adapter form a single, integral piece.

16. The fitting assembly of claim 1, further comprising a nut made of iron.

17. The fitting assembly of claim 1, wherein the adapter is made of cast iron.

18. The fitting assembly of claim 1, wherein the adapter is made of ductile iron.

19. An adapter for forming a fluid-tight seal with a stainless steel tube, comprising:
an adapter, wherein the adapter is made of iron.

20. The adapter of claim 19, further comprising a seal seat to be placed adjacent to a cut end of the stainless steel tube;
wherein the seal seat is made of a material that is different than a material that the adapter is made of.

21. The adapter of claim 20, wherein the seal seat and the adapter are separate pieces.

22. The adapter of claim 20, wherein the seal seat is an insert that is joined to the adapter.

23. The adapter of claim 20, wherein the seal seat and the adapter form a single, integral piece.

24. The adapter of claim 20, wherein the seal seat is made of a material that is softer than a material that the stainless steel tube is made of.

25. The adapter of claim 24, wherein the seal seat is made of brass.

26. The adapter of claim 20, wherein the seal seat is made of a material that is harder than a material that the stainless steel tube is made of.

27. The adapter of claim 26, wherein the seal seat is made of hardened martensitic stainless steel.

28. The adapter of claim 26, wherein the seal seat is made of hardened tool steel.

29. The adapter of claim 20, wherein the seal seat is coated with a coating material, wherein the coating material is a corrosion-resistant material, a wear-resistant material, or a material that is harder than a material that the stainless steel tube is made of.
